(19) United States
(12) Patent Application Publication
(10) Pub. No.: US 2018/0137030 A1
(43) Pub. Date: May 17, 2018

(54) AUTOMATIC GENERATION OF AN EXCEPTION DETECTOR FOR DETERMINING AN OVERFLOW CONDITION

(71) Applicant: Microsoft Technology Licensing, LLC, Redmond, WA (US)

(72) Inventors: Shachar Raindel, Redmond, WA (US); Derek Chiou, Austin, TX (US)

(21) Appl. No.: 15/446,983

(22) Filed: Mar. 1, 2017

Related U.S. Application Data
(60) Provisional application No. 62/421,962, filed on Nov. 14, 2016.

(51) Int. Cl. G06F 11/36; G06F 11/25

(52) U.S. Cl. CPC G06F 11/3648; G06F 11/25; G06F 11/3612; G06F 11/3688

(57) ABSTRACT

Systems and methods for automatic generation of an exception detector for determining an overflow condition are provided. In one example, a method including receiving code corresponding to at least one block of the hardware module, wherein the code providing at least a first value for a first variable, a second value for a second variable, or an operation to be performed using at least one of the first variable or the second variable, is provided. The method may further include automatically generating an exception detector to determine whether an overflow condition is triggered by at least one of the operation, the first variable, or the second variable.

### BACKGROUND

Hardware is sometimes developed using tools that specify its functionality and its potential structure. These tools process code similar to the programming language C. Each logic block may be described by the function or the operation that the logic block will perform once created as part of a semiconductor integrated circuit or another type of circuit. As an example, a logic block may be created to perform a multiply operation on two variables. To reduce the size of the logic needed to implement the operation and store the inputs and outputs, the bit-size of each of the variables is sometimes reduced. The reduction in the bit-size may reduce the number of memory cells needed to store the values corresponding to the variables.

Such reduction of the bit-size can, however, produce adverse results including undefined behavior and incorrect outputs.

### SUMMARY

In one example, the present disclosure relates to a method including receiving code corresponding to at least one block of the hardware module, wherein the code providing at least a first value for a first variable, a second value for a second variable, or an operation to be performed using at least one of the first variable or the second variable. The method may further include automatically generating an exception detector to determine whether an overflow condition is triggered by at least one of the operation, the first variable, or the second variable.

In another aspect, the present disclosure relates to a computer-readable medium comprising instructions corresponding to a method. The method may include receiving code corresponding to at least one block of the hardware module, wherein the code providing at least a first value for a first variable, a second value for a second variable, or an operation to be performed using at least the first variable or the second variable. The method may further include automatically generating an exception detector to determine whether an overflow condition is triggered by at least one of the operation, the first variable, or the second variable. The method may further include during processing of the code corresponding to the at least one block of the hardware module, based on the exception detector indicating that the overflow condition is triggered by the at least one of the operation, the first variable, or the second variable, automatically providing at least one of: (1) a first user-defined value for replacing the first value for the first variable triggering the overflow condition, (2) a second user-defined value for replacing the second value for the second variable triggering the overflow condition (3) at least one user-defined relationship among values corresponding to any of variables triggering the overflow condition, (4) a value for replacing a result of the at least one operation triggering the overflow condition, (5) a third variable for replacing the first variable triggering the overflow condition, or (6) a fourth variable for replacing the second variable triggering the overflow condition.

In yet another aspect, the present disclosure relates to a system comprising at least one processor and at least one memory including instructions. The instructions may be for: (1) receiving code corresponding to at least one block of the hardware module, wherein the code providing at least a first value for a first variable, a second value for a second variable, or an operation to be performed using the first variable or the second variable, (2) automatically generating an exception detector to determine whether an overflow condition is triggered by at least one of the operation, the first variable, or the second variable, and (3) during processing of the code corresponding to the at least one block of the hardware module, despite the exception detector indicating that the overflow condition is triggered by the at least one of the operation, the first variable, based on a value of at least one marker embedded in the code ignoring the overflow condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a system environment in accordance with one example;

FIG. 2 is a block diagram of a computing system for implementing a system of FIG. 1 in accordance with one example;

FIG. 3 is a diagram showing hardware corresponding to an adder with an overflow condition detection in accordance with one example;

FIG. 4 is a diagram showing hardware corresponding to an array with an overflow condition detection in accordance with one example;

FIG. 5 is a flow chart of a method in accordance with one example;

FIG. 6 is a flow chart of a method in accordance with another example; and

FIG. 7 is a diagram showing hardware corresponding to a hardware block with multiple adders and dummy pipeline stages.

### DETAILED DESCRIPTION

Examples described in this disclosure relate to systems and methods for automatic generation of an exception detector during development of a hardware module. Hardware modules include, but are not limited to Field-Programmable Gate Arrays (FPGAs), Application-Specific Integrated Circuits (ASICs), Application-Specific Standard Products (ASSPs), System-on-a-Chip systems (SoCs), Complex Programmable Logic Devices (CPLDs), Digital-Signal Processors (DSPs) or other similar hardware modules. Hardware modules such as FPGAs, ASICs, ASSPs, SoCs, and CPLDs are developed using electronic design automation (EDA) tools that may specify various logic blocks of the hardware modules. Each logic block may be described based on the function or the operation that the logic block will perform once created as part of a semiconductor integrated circuit or another type of circuit. As an example, a logic block may be created to perform a multiply operation on two variables. In this disclosure, a “variable” may refer to an input on which any operation, such as a sum operation, a multiply operation, or any other type of operation may be performed. The term “variable” may refer to an output of any operation as well. The term “variable” further includes inputs or outputs that may be constants. The level of abstraction for the description of the logic blocks may be dictated by the type of user of the EDA tools. As an example, software programmers may prefer an EDA tool that lets them develop a hardware module in a code similar to the programming language C.

Each logic block of a hardware module may be described based on the function or the operation that the logic block will perform once formed as part of a semiconductor integrated circuit or another type of circuit. As an example, a logic block may be designed to perform a multiply operation on two variables. As part of a high-level representation of the hardware module, to reduce the size of the logic needed to implement the operation, the bit-size of each of the variables may be reduced. Such reduction of the bit-size can, however, produce adverse results including undefined behavior and incorrect outputs. The present disclosure provides systems and methods that may, upon detection of an error condition such as overflow, generate code to perform an “emergency stop” of during simulation of the logic block corresponding to the hardware module. In addition, the systems and methods may expose internal state or inputs to the developer of the hardware to diagnose the problems caused by error conditions, such as an overflow. This may advantageously allow catching of such errors at an earlier stage during the development of the hardware and the diagnosing of exactly which variables may need to be enlarged or changed otherwise. As an example, a high-level synthesis (HLS) compiler can detect the possibility for an overflow (or lack thereof) during compilation. In this example, if the HLS compiler is generating the code for an addition operation with an operand width of X number of bits for one argument and Y number of bits for the other argument, there is a possibility for overflow if and only if the result is stored in a variable whose bit size is less than MAX (X, Y)+1. A more advanced compiler may propagate bit size constants through the code, so if one of the operands is bit masked to a smaller size, shifted right, etc. a potential overflow could be detected during compile time. Table 1, below, shows example code for addition operations where integer overflow may occur.

```
TABLE 1
      sc_int<10> a;
      sc_int<10> b;
      sc_int<10> sum;
      sum = a+b,
      sc_int<10> a;
      sc_int<8> b;
      sc_int<8> sum;
      a = a & 0xFF,
      sum = a+b, // Can still suffer overflow, for example if a == 0x80
and b == 0x80
```

Table 2, below, shows an example code for addition operations where integer overflow is not possible.

TABLE 2

sc_int<10> a;
sc_int<10> b;
sc_int<11> sum;
sum = a+b;
sc_int<10> a;
sc_int<8> b;
sc_int<8> sum;
a = a & 0x7F,
sum = a+b, // a + b will at most be 0x7F+0x7F == 0xFE

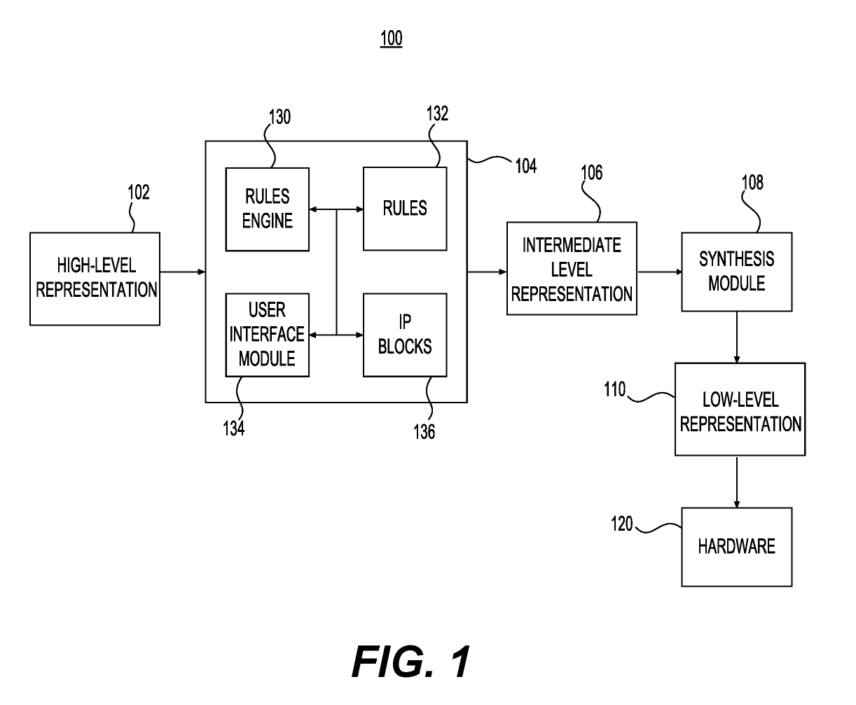

FIG. 1 is a block diagram of a system environment 100 in accordance with one example. High-level representation 102 of a hardware module may be processed using system 104. In one example, high-level representation 102 of the hardware module may correspond to code in a programming language, such as SystemC. In one example, high-level representation 102 may include details concerning inputs, outputs, variables, operations, and high-level modeling of the interaction among these to describe a logic block of a hardware module. In one example, high-level representation 102 may not include any timing constraints imposed by an underlying technology. Table 3 below shows example code for an example adder.

TABLE 3

void do_add( )
{
sc_int<10> a_val;
sc_int<10> b_val;
sc_int<10> sum_val;
try {

a_val = a.read( );
b_val = b.read( );

sum_val = a_val + b_val;

} catch(const HLSIntOverflowException &e) {

err.write(e.Type,e.Line,e.OriginalValue);
sum_val = SPECIALIZED_ERROR_VALUE; // For example,
floating

point non-annotated number (NAN), or reserved/known impossible
value

}
sum.write(sum_val);

}

System 104 may generate code corresponding to a first-level representation of the hardware module. In this example, the first-level representation of the hardware module may be code corresponding to an intermediate-level representation 106 of the hardware module. In one example, intermediate-level representation 106 of the hardware module may correspond to register-transfer level code in a language, such as Verilog or VHDL. As an example, Table 4 below shows an example Verilog code corresponding to intermediate-level representation 106 of the code.

TABLE 4

module adder
(in_a, in_b, sum_out, carry_out);
input in_a;
input in_b;
output sum_out, carry_out;
xor(sum_out, in_a, in_b);
and(carry_out, in_a, in_b);
wire w_sum1;
endmodule

Consistent with another example, Table 5 below shows example code corresponding to high-level representation of an array-related operation.

TABLE 5

void do_add_array( )
{
int a_val = a.read( );
int b_val = b.read( );
int sum_val;
try {
arr[a_val] = arr[a_val] + b_val;
sum_val = arr[a_val];
} catch (const HLSAddrOverflowException &e) {

err.write(e.Type,e.Line,e.OriginalValue);
sum_val = SPECIALIZED_ERROR_VALUE; // For example,

floating point non-annotated number (NAN), or reserved/known
impossible value
}
sum.write(sum_val);

}

Intermediate-level representation 106 of the hardware module may be processed using a synthesis module 108 to generate a low-level representation 110 of the hardware module. Low-level representation 110 of the hardware module may be logic netlist or a similar low-level representation that can be further processed to create chip-level schematics for the hardware module to develop hardware 120 corresponding to the hardware module. In another example, system 104 may process the first-level code to generate code corresponding to the hardware module. Although FIG. 1 shows a certain number of components of system environment 100 arranged in a certain manner, there could be more or fewer number of components that are shown in FIG. 1 and those components could be arranged differently from as shown in FIG. 1. For example, system 104 may process a first-level representation of code corresponding to a hardware module and generate a second-level representation of the code that may include the logic netlist and other details for simulating the hardware module.

With continued reference to FIG. 1, in one example, system 104 may include a rules engine 130, rules 132, user interface module 134, and IP blocks 136. Rules engine 130 may include instructions to process rules, provided via rules 132, against high-level representation 102 of at least one logic block corresponding to a hardware module. A user, such as a developer, may interact with system 104 via user interface module 134. IP blocks 136 may include logic blocks that are pre-configured and provide a specific functionality, such as an input/output port, a clock module, a memory interface, or other types of standardized logic blocks. High-level representation 102 of the hardware module may include a reference to any needed IP blocks 136 and rules engine 130 may process such references to include intermediate-level representation 106 of such IP blocks. In one example, system 104 may further include a class library of predefined classes, functions, macros, or other such code that may be used to install and use system 104. The generation of intermediate-level representation 106 may include creation of a module hierarchy, which may include modules, ports, primitive channels, and processes. Ports may be bound to channels to allow modules to communicate with each other. System 104 may include a kernel that may be executed using a processor to enable the functionality associated with rules engine 130 and rules 132. User interface module 134 may be a public shell providing access to system 104. Rules engine 130 may include a scheduler that may trigger or resume the execution of processes corresponding to the high-level representation 102 of a hardware module. Scheduler may also be responsible for initiating processes that may result in generation of messages for the developer.

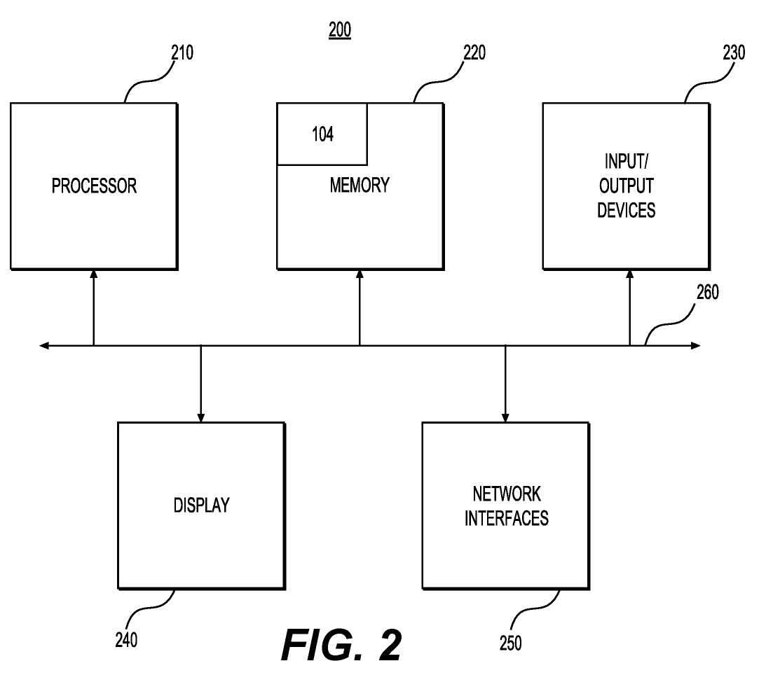

FIG. 2 is a block diagram of a computing system 200 for implementing system 104 of FIG. 1. Computing system 200 may include a processor 210, a memory 220, input/output devices 230, display 240, and network interfaces 250. Each of these components may be connected to each other (as needed for the functionality of system 104) via a bus system 260. Processor 210 may execute instructions stored in memory 220. Input/output devices 230 may include devices such as a keyboard, a mouse, voice recognition processor, or touch screens. Display 240 may be any type of display, such as LCD, LED, or other types of display. Network interfaces 250 may include communication interfaces, such as Ethernet, cellular radio, Bluetooth radio, UWB radio, or other types of wireless or wired communication interfaces. Memory 220 may include components corresponding to system 104. This way, in this example, processor 210 may execute instructions corresponding to these components to enable the functionality associated with system 104.

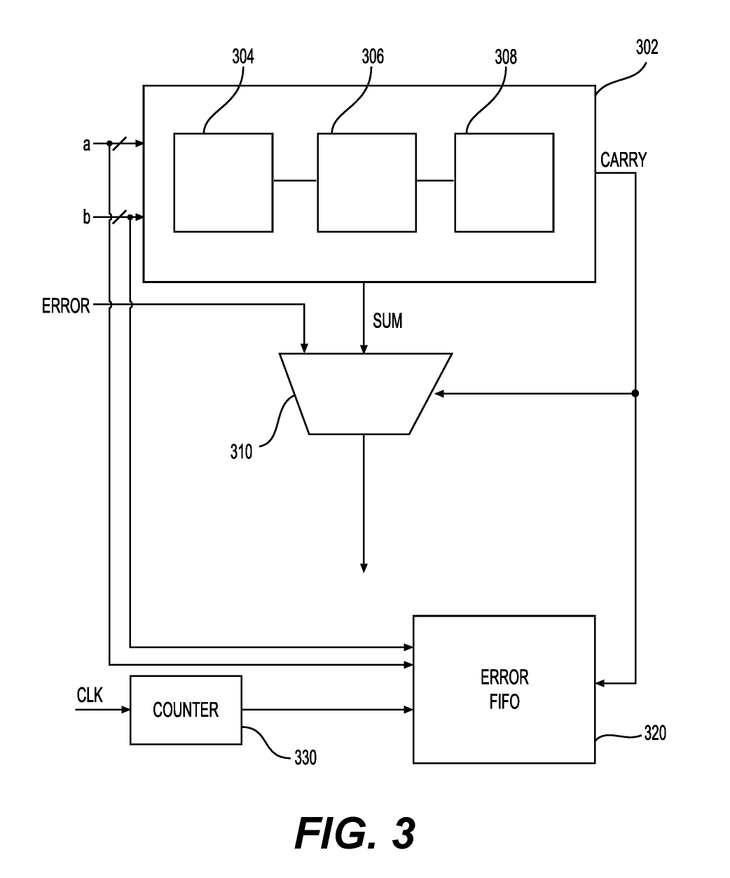

FIG. 3 is a diagram showing hardware 300 corresponding to an adder 302 with an overflow condition detection in accordance with one example. Adder 302 may be used to perform an add operation on variables a and b, as shown. Adder 302 may include several half-adders 304, 306, and 308. Adder 302 may produce a SUM value and a CARRY value. Hardware 300 may further include a multiplexer 310 and an ERROR FIFO 320. Multiplexer 310 may have two inputs, where one input may be coupled to receive the SUM value and the other input may be coupled to receive an ERROR value. The CARRY value may be used as a control bit for multiplexer 310. As an example, if the CARRY value is logic low, then multiplexer 310 may provide the SUM value as the output. Alternatively, if the CARRY value is logic high, then multiplexer 310 may provide the ERROR value as the output. The CARRY value may also be stored in ERROR FIFO 320. The values corresponding to the two variables (a and b) being added using adder 302 may also be stored in ERROR FIFO 320. In addition, a free-running counter 330 may receive a clock signal (CLK) and its output may be coupled to ERROR FIFO 320 as well. This way the inputs and the outputs that may have caused an overflow may be exposed to a developer of hardware 300. Although FIG. 3 shows a certain number of components of hardware 300 arranged in a certain manner, there could be more or fewer number of components arranged differently. As an example, multiplexer 310 may be omitted when the hardware designer does not want the operation to be impacted and instead wants only to get the ERROR value. In one embodiment, the developer may specify how to handle the error. For example, the developer may specify that the ERROR value encode at least some of the inputs or certain portions of the inputs as part of the ERROR value.

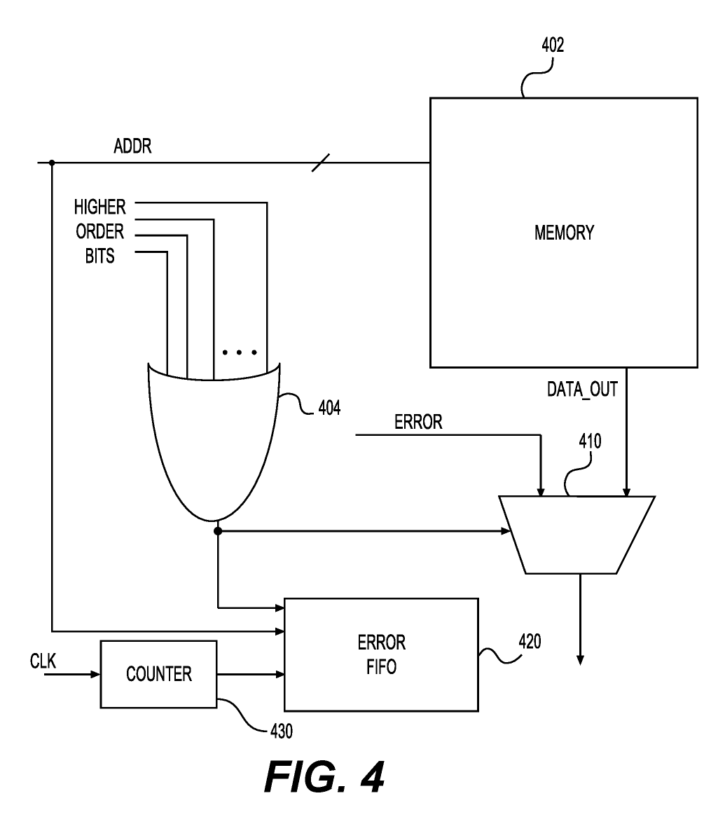

FIG. 4 is a diagram showing hardware 400 corresponding to a memory 402, e.g., an array, with an overflow condition detection in accordance with one example. In response to an address (ADDR) provided via the address bus, the number of bits that can be carried by the address bus may be provided to memory 402. In response, memory 402 may provide a data value, such as DATA_OUT. If the address contains more bits than the width of the address bus, then logic circuits may be used to detect the overflow condition. As an example, logic circuits may be used to process the higher order bits and generate an error value indicating the overflow condition. In one example, the higher order bits (HIGHER ORDER BITS) of the address may be coupled as inputs to an OR gate 404. Hardware 400 may further include a multiplexer 410 and an ERROR FIFO 420. Multiplexer 410 may have two inputs, where one input may be coupled to receive the DATA_OUT value and the other input may be coupled to receive an ERROR value. The output of OR gate 404 may be used as a control bit for multiplexer 410. As an example, if the output value from OR gate 404 is logic low, then multiplexer 410 may provide the DATA_OUT value as the output. Alternatively, if the output value from OR gate 404 is logic high, then multiplexer 410 may provide the ERROR value as the output. The output value from OR gate 404 may also be stored in ERROR FIFO 420. The address (ADDR) may also be coupled to ERROR FIFO 420, such that any relevant bits of the address (or addresses) may be stored in ERROR FIFO. In addition, a free-running counter 430 may receive a clock signal (CLK) and its output may be coupled to ERROR FIFO 420 as well. This way the inputs and the outputs that may have caused an overflow may be exposed to a developer of hardware 400. Although FIG. 4 shows a certain number of components of hardware 400 arranged in a certain manner, there could be more or fewer number of components arranged differently. As an example, multiplexer 410 may be omitted when the hardware designer does not want the operation to be impacted and instead wants only to get an indication of an error via ERROR FIFO 420.

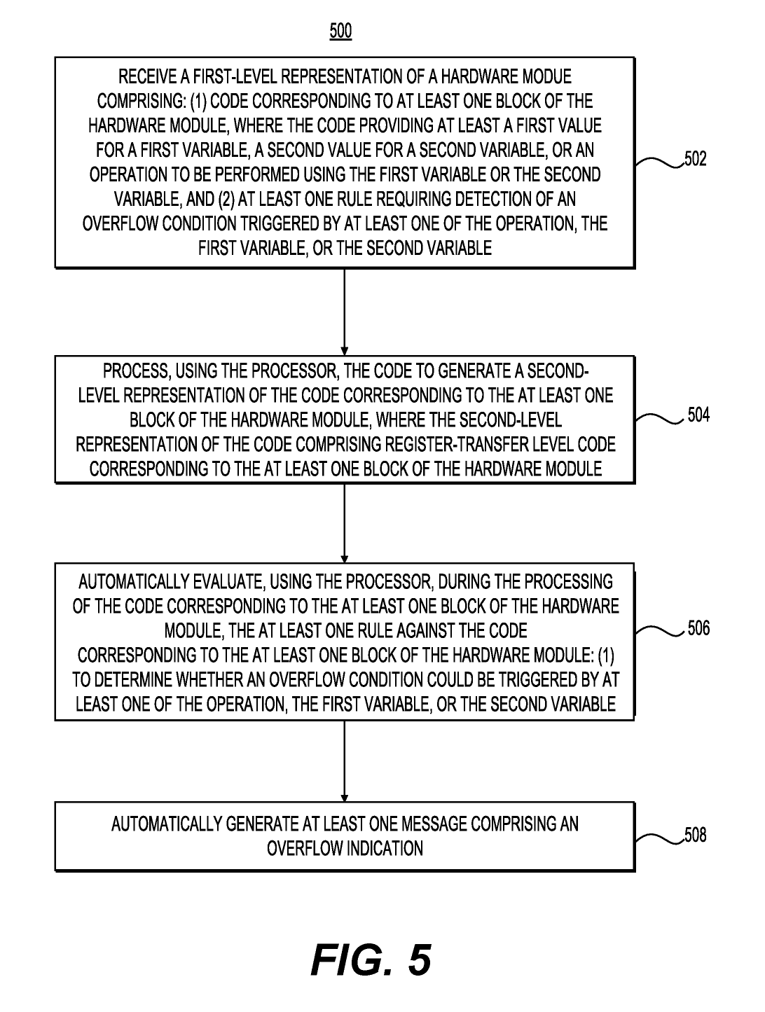

FIG. 5 is a flow chart 500 of a method in accordance with one example. In this example, the various steps recited as part of flow chart 500 may be performed by system 104 of FIG. 1. As noted earlier system 104 of FIG. 1 may include various components, at least a subset of which may be executed by processor 210 of FIG. 2. As part of step 502, system 104 may receive a high-level representation of a hardware module comprising: (1) code corresponding to at least one block of the hardware module, where the code may provide at least a first value for a first variable, a second value for a second variable, or an operation to be performed using the first variable and the second variable, and (2) at least one rule requiring detection of an overflow condition that may be triggered by at least one of the operation, the first variable, or the second variable. As an example, as part of this step system 104 may receive a high-level representation comprising code corresponding to an adder as shown in Table 3. In step 504, system 104 may process, using the processor, the code to generate an intermediate-level representation of the code corresponding to the at least one block of the hardware module. As an example, as part of this step, system 104 may process the code corresponding to the adder (e.g., Table 3) to generate an intermediate-level representation as shown in Table 4. In one example, the intermediate-level representation may correspond to register-level transfer code corresponding to the at least one logic block, e.g., the adder.

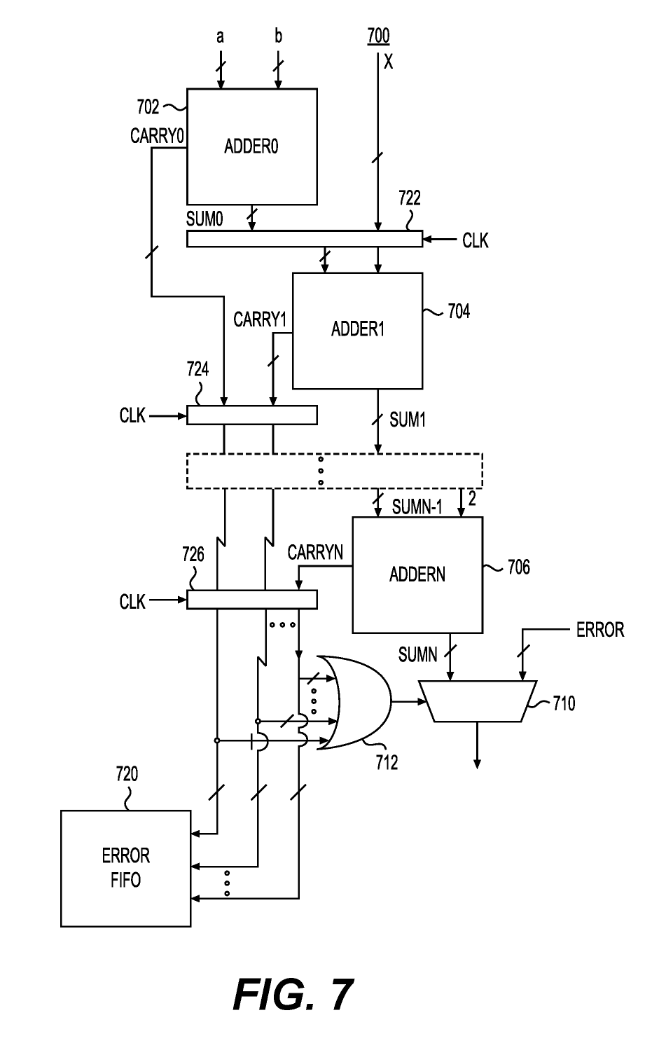

With continued reference to FIG. 5, in step 506 system 104 may automatically evaluate, using the processor (e.g., processor 210 of FIG. 2) during the processing of the code corresponding to the at least one block of the hardware module, the at least one rule against the code corresponding to the at least one block of the hardware module to determine whether an overflow condition could be triggered by the at least one of the operation, the first variable, or the second variable. This step may include automatically generating an exception detector to determine whether an overflow condition is triggered by at least one of the operation, the first variable, or the second variable. In this example, the rule application may include executing code that determines whether an operation, such as an add operation, may cause an overflow condition. As part of this step, in one embodiment, system 104 may assume that certain operations, for example, summing operations or multiplication operations can always cause an overflow. In certain instances, system 104 may not detect the possibility of an overflow. Next, in step 508, system 104 may automatically generate at least one message comprising an overflow condition. In this example, the message may be generated by throwing an exception. In addition, based on the exception detector indicating that the overflow condition is triggered by the at least one of the operation, the first variable, or the second variable, this step may include automatically providing at least one of: (1) a first user-defined value for replacing the first value for the first variable triggering the overflow condition, (2) a second user-defined value for replacing the second value for the second variable triggering the overflow condition (3) at least one user-defined relationship among values corresponding to any of variables triggering the overflow condition, (4) a value for replacing a result of the at least one operation triggering the overflow condition, (5) a third variable for replacing the first variable triggering the overflow condition, or (6) a fourth variable for replacing the second variable triggering the overflow condition. Thus, if an addition operation causes an overflow, system 104 may skip all the lines of code going forward from the line for the addition operation that caused the overflow. Example hardware 300 of FIG. 3 and hardware 400 of FIG. 4 may include predicated pipeline stages following the error bit to handle the skipping of the lines of code. Additional details relating to one example of such hardware are shown and described with respect to FIG. 7. The message may include not only an indication of an overflow condition, but also an error type (e.g., e.Type in Table 3), a line number corresponding to the operation or the variable that caused the exception (e.g., e.Line in Table 3), and an original value corresponding to the variable or the result that caused the exception (e.g., e.OriginalValue in Table 3). In addition, upon detection of an error condition, such as overflow, system 104 may also generate code for performing an “emergency stop” of the processing of the high-level representation of the logic block corresponding to the hardware module. Hardware 300 or 400 generated from the code may perform the emergency stop based on the code generated by system 104 as part of this step. System 104 may further generate code to expose internal states and inputs (e.g., the variables) to the developer to allow the developer to debug the high-level representation 102 of the hardware module. System 104 may expose the internal states and inputs relating to hardware 300 and hardware 400 to the developer during the development cycle. As an example, any values stored in ERROR FIFO may be presented to the developer using user interface module 134 of system 104. Although FIG. 5 shows certain number of steps being performed in a certain order, method 500 may include more or fewer steps performed in a different order.

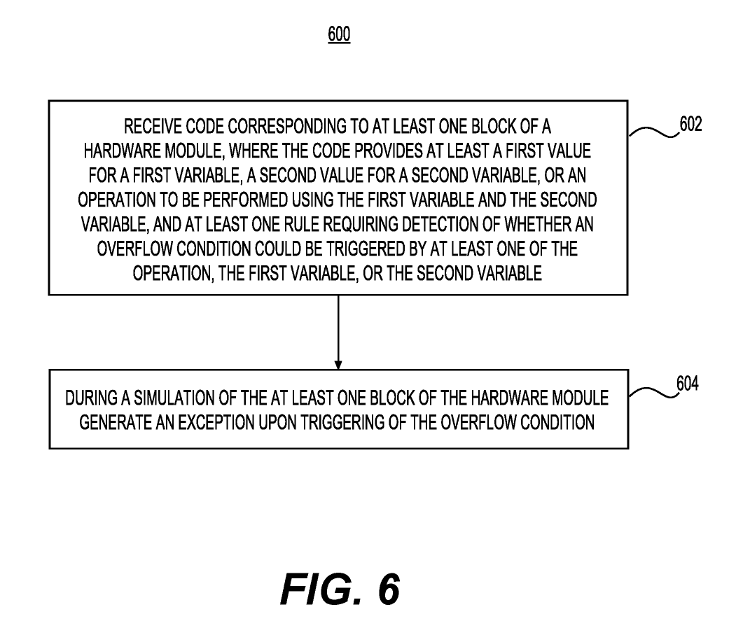

FIG. 6 is a flow chart of a method 600 in accordance with another example. In this example, the various steps recited as part of flow chart 600 may be performed by system 104 of FIG. 1. As noted earlier system 104 of FIG. 1 may include various components, at least a subset of which may be executed by processor 210 of FIG. 2. As part of step 602 system 104 may receive code corresponding to at least one block of the hardware module, where the code may provide at least a first value for a first variable, a second value for a second variable, and an operation to be performed using the first variable and the second variable, and at least one rule requiring detection of whether an overflow condition could be triggered by at least one of the operation, the first variable, or the second variable. As an example, as part of this step system 104 may receive code corresponding to an adder as shown in Table 3. In step 604 system 104 may process, using the processor the code to generate an intermediate-level representation of the code corresponding to the at least one block of the hardware module. As an example, as part of this step system 104 may process the code corresponding to the adder (e.g., Table 3) to generate an intermediate-level representation as shown in Table 4. In one example, the intermediate-level representation may correspond to register-level transfer code corresponding to the at least one logic block, e.g., the adder.

The exception may include not only an indication of an overflow condition, but also an error type (e.g., e.Type in Table 3), a line number corresponding to the operation or the variable that caused the exception (e.g., e.Line in Table 3), and an original value corresponding to the variable or the result that cause the exception (e.g., e.OriginalValue in Table 3). In addition, upon detection of an error condition, such as overflow, system 104 may also generate code for performing an “emergency stop” of the processing of the high-level representation of the logic block corresponding to the hardware module. Hardware 300 or 400 generated from the code may perform the emergency stop based on the code generated by system 104 as part of this step. System 104 may further generate code to expose internal states and inputs (e.g., the variables) to the developer to allow the developer to debug the high-level representation 102 of the hardware module. System 104 may expose the internal states and inputs relating to hardware 300 and hardware 400 to the developer during the development cycle. Although FIG. 6 shows certain number of steps being performed in a certain order, method 600 may include more or fewer steps performed in a different order.

FIG. 7 is a diagram showing hardware corresponding to a hardware block 700 with multiple adders and predicated pipeline stages. In this example, the code corresponding to hardware block 700 may include multiple adders (e.g., N number of adders, where N is a positive integer) as shown in FIG. 7. A first adder, e.g., ADDER0 702 may receive values corresponding to variables a and b. ADDER0 702 may generate a sum value (e.g., SUM0) that may be stored in a storage element 722. Storage element 722 may be a clocked register that may include a field to store the sum value. ADDER0 702 may also generate a carry, e.g., CARRY0. Storage element 722 may further include a field to store a value corresponding to another variable, e.g., the value of the variable X. The sum value, SUM0, may be provided as a first input another adder, e.g., ADDER1 704. The value for the variable X may be provided as a second input to this adder. ADDER1 704 may generate a sum value (e.g., SUM1) that may be stored in a storage element 724. Storage element 724 may be a clocked register that may include a field to store the sum value. ADDER1 704 may also generate a carry, e.g., CARRY1. Storage element 724 may be used to store respective values for the carry (e.g., a value corresponding to each of CARRY0 and CARRY1) produced by ADDER0 702 and ADDER1 704, respectively. The sum value, e.g., SUM1 produced by ADDER1 704 may be stored in another storage element like storage element 722. In this manner, N−1 number of adders may generate sum values culminating in a sum value (e.g., SUMN−1) generated by the N−1^{st} adder. Similarly, N−1 number of adders may generate various carry values as shown with respect to the example in FIG. 7. The various carry values, including for example CARRY0, CARRY1, and CARRYN may be coupled to ERROR FIFO 720 for storage. The bus lines used to communicate these carry signals may also be coupled as inputs to an OR gate 712. The output of OR gate 712 may be used as a control signal for a multiplexer 710. Multiplexer 710 may receive two inputs via each of its two input terminals. One of the inputs may be the SUMN value and the other input may be the ERROR value. The output terminal of multiplexer 710 may provide as an output either the SUMN value or the ERROR value depending upon a value of the input to its control terminal.

In conclusion, the present disclosure relates to a method including receiving code corresponding to at least one block of the hardware module, wherein the code providing at least a first value for a first variable, a second value for a second variable, or an operation to be performed using at least one of the first variable or the second variable. The method may further include automatically generating an exception detector to determine whether an overflow condition is triggered by at least one of the operation, the first variable, or the second variable.

The method may further include the exception detector determining a location in the code of a variable or an operation that triggered the overflow condition. In addition, the method may further include during processing of the code corresponding to the at least one block of the hardware module, based on the exception detector indicating that the overflow condition is triggered by the at least one of the operation, the first variable, or the second variable, automatically generating an exception. The automatically generating the exception may further include providing at least one message comprising (1) a first location in the code of the operation, to be performed using the first value for the first variable and the second value for the second variable, that triggered the overflow condition or (2) a second location in the code related to: (a) providing the first value for the first variable that triggered the overflow condition or (b) providing the second value for the second variable that triggered the overflow condition. The automatically generating the exception may further include providing at least one message comprising at least one of: (1) an original value for the first variable that triggered the overflow condition or (2) an original value for the second variable that triggered the overflow condition. In addition, the method may further include during processing of the code corresponding to the at least one block of the hardware module, requiring evaluation of an optional marker associated with at least one of the first variable, the second variable, the at least one operation, a variable for storing a result of the at least one operation, or a portion of the code corresponding to the at least one block of the hardware module.

The method may further include suppressing the at least one message based on a result of the evaluation of the optional marker. The optional marker may comprise an annotation indicating whether an overflow condition is expected with respect to the at least one of the first variable, the second variable, the at least one operation, the variable for storing the result of the at least one operation, or the portion of the code corresponding to the at least one block of the hardware module.

The method may further include automatically processing the code corresponding to the at least one block of the hardware module to generate a low-level representation of the code comprising at least one of timing information or routing information for the at least one block of the hardware module.

In another aspect, the present disclosure relates to a computer-readable medium comprising instructions corresponding to a method. The method may include receiving code corresponding to at least one block of the hardware module, wherein the code providing at least a first value for a first variable, a second value for a second variable, or an operation to be performed using at least the first variable or the second variable. The method may further include automatically generating an exception detector to determine whether an overflow condition is triggered by at least one of the operation, the first variable, or the second variable. The method may further include during processing of the code corresponding to the at least one block of the hardware module, based on the exception detector indicating that the overflow condition is triggered by the at least one of the operation, the first variable, or the second variable, automatically providing at least one of: (1) a first user-defined value for replacing the first value for the first variable triggering the overflow condition, (2) a second user-defined value for replacing the second value for the second variable triggering the overflow condition (3) at least one user-defined relationship among values corresponding to any of variables triggering the overflow condition, (4) a value for replacing a result of the at least one operation triggering the overflow condition, (5) a third variable for replacing the first variable triggering the overflow condition, or (6) a fourth variable for replacing the second variable triggering the overflow condition.

The automatically providing may further comprise providing at least one message comprising (1) a first location in the code of the operation, to be performed using the first value for the first variable and the second value for the second variable, that triggered the overflow condition or (2) a second location in the code related to: (a) providing the first value for the first variable that triggered the overflow condition or (b) providing the second value for the second variable that triggered the overflow condition. The automatically providing may further comprise providing at least one message comprising at least one of: (1) an original value for the first variable that triggered the overflow condition or (2) an original value for the second variable that triggered the overflow condition.

The computer-readable medium may also comprise instructions for the method to include the exception detector determining a location in the code of a variable or an operation that triggered the overflow condition. The computer-readable medium may also comprise instructions for the method to include during the processing of the code corresponding to the at least one block of the hardware module, requiring evaluation of an optional marker associated with at least one of the first variable, the second variable, the at least one operation, a variable for storing a result of the at least one operation, or a portion of the code corresponding to the at least one block of the hardware module.

The computer-readable medium may also comprise instructions for the method to include suppressing the at least one message based on a result of the evaluation of the optional marker. The optional marker may comprise an annotation indicating whether an overflow condition is expected with respect to at least one of the first variable, the second variable, the at least one operation, the variable for storing the result of the at least one operation, or the portion of the code corresponding to the at least one block of the hardware module.

The computer-readable medium may also comprise instructions for the method to include automatically processing the code corresponding to the at least one block of the hardware module to generate a low-level representation of the code comprising at least one of timing information or routing information for the at least one block of the hardware module.

In yet another aspect, the present disclosure relates to a system comprising at least one processor and at least one memory including instructions. The instructions may be for: (1) receiving code corresponding to at least one block of the hardware module, wherein the code providing at least a first value for a first variable, a second value for a second variable, or an operation to be performed using the first variable or the second variable, (2) automatically generating an exception detector to determine whether an overflow condition is triggered by at least one of the operation, the first variable, or the second variable, and (3) during processing of the code corresponding to the at least one block of the hardware module, despite the exception detector indicating that the overflow condition is triggered by the at least one of the operation, the first variable, based on a value of at least one marker embedded in the code ignoring the overflow condition.

The at least one memory may further comprise instructions for the exception detector determining a location in the code of a variable or an operation that triggered an overflow condition. The at least one memory may further comprise instructions for, during processing of the code corresponding to the at least one block of the hardware module, based on the exception detector indicating that the overflow condition is triggered by the at least one of the operation, the first variable, or the second variable, automatically generating an exception wherein the at least one message further comprising (1) a first location in the code of the operation, to be performed using the first value for the first variable or the second value for the second variable, that triggered the overflow condition or (2) a second location in the code related to: (a) providing the first value for the first variable or (b) providing the second value for the second variable.

It is to be understood that the methods, modules, and components depicted herein are merely exemplary. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with the examples described in this disclosure can also include instructions stored in a non-transitory media, e.g., memory 220 or other types of non-transitory media. The term “non-transitory media” as used herein refers to any media storing data and/or instructions that cause a machine, such as processor 210, to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory, such as DRAM, SRAM, a cache, or other such media. Non-transitory media is distinct from, but can be used in conjunction with, transmission media. Transmission media is used for transferring data and/or instruction to or from a machine, such as processor 100. Exemplary transmission media, include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method comprising:
receiving code corresponding to at least one block of the hardware module, wherein the code providing at least a first value for a first variable, a second value for a second variable, or an operation to be performed using at least one of the first variable or the second variable; and
automatically generating an exception detector to determine whether an overflow condition is triggered by at least one of the operation, the first variable, or the second variable.

2. The method of claim 1 further comprising the exception detector determining a location in the code of a variable or an operation that triggered the overflow condition.

3. The method of claim 1 further comprising, during processing of the code corresponding to the at least one block of the hardware module, based on the exception detector indicating that the overflow condition is triggered by the at least one of the operation, the first variable, or the second variable, automatically generating an exception.

4. The method of claim 3, wherein the automatically generating the exception further comprising providing at least one message comprising (1) a first location in the code of the operation, to be performed using the first value for the first variable and the second value for the second variable, that triggered the overflow condition or (2) a second location in the code related to: (a) providing the first value for the first variable that triggered the overflow condition or (b) providing the second value for the second variable that triggered the overflow condition.

5. The method of claim 3, wherein the automatically generating the exception further comprising providing at least one message comprising at least one of: (1) an original value for the first variable that triggered the overflow condition or (2) an original value for the second variable that triggered the overflow condition.

6. The method of claim 3 further comprising, during the processing of the code corresponding to the at least one block of the hardware module, requiring evaluation of an optional marker associated with at least one of the first variable, the second variable, the at least one operation, a variable for storing a result of the at least one operation, or a portion of the code corresponding to the at least one block of the hardware module.

7. The method of claim 5 further comprising suppressing the at least one message based on a result of the evaluation of the optional marker.

8. The method of claim 6, wherein the optional marker comprising an annotation indicating whether an overflow condition is expected with respect to the at least one of the first variable, the second variable, the at least one operation, the variable for storing the result of the at least one operation, or the portion of the code corresponding to the at least one block of the hardware module.

9. The method of claim 1 further comprising automatically processing the code corresponding to the at least one block of the hardware module to generate a low-level representation of the code comprising at least one of timing information or routing information for the at least one block of the hardware module.

10. A computer-readable medium comprising instructions corresponding to a method, the method comprising:
receiving code corresponding to at least one block of the hardware module, wherein the code providing at least a first value for a first variable, a second value for a second variable, or an operation to be performed using at least the first variable or the second variable;
automatically generating an exception detector to determine whether an overflow condition is triggered by at least one of the operation, the first variable, or the second variable; and
during processing of the code corresponding to the at least one block of the hardware module, based on the exception detector indicating that the overflow condition is triggered by the at least one of the operation, the first variable, or the second variable, automatically providing at least one of: (1) a first user-defined value for replacing the first value for the first variable triggering the overflow condition, (2) a second user-defined value for replacing the second value for the second variable triggering the overflow condition (3) at least one user-defined relationship among values corresponding to any of variables triggering the overflow condition, (4) a value for replacing a result of the at least one operation triggering the overflow condition, (5) a third variable for replacing the first variable triggering the overflow condition, or (6) a fourth variable for replacing the second variable triggering the overflow condition.

11. The computer-readable medium of claim 10, wherein the method further comprising the exception detector determining a location in the code of a variable or an operation that triggered the overflow condition.

12. The computer-readable medium of claim 10, wherein the automatically providing further comprising providing at least one message comprising (1) a first location in the code of the operation, to be performed using the first value for the first variable and the second value for the second variable, that triggered the overflow condition or (2) a second location in the code related to: (a) providing the first value for the first variable that triggered the overflow condition or (b) providing the second value for the second variable that triggered the overflow condition.

13. The computer-readable medium of claim 10, wherein the automatically providing further comprising providing at least one message comprising at least one of: (1) an original value for the first variable that triggered the overflow condition or (2) an original value for the second variable that triggered the overflow condition.

14. The computer-readable medium of claim 10, wherein the method further comprising, during the processing of the code corresponding to the at least one block of the hardware module, requiring evaluation of an optional marker associated with at least one of the first variable, the second variable, the at least one operation, a variable for storing a result of the at least one operation, or a portion of the code corresponding to the at least one block of the hardware module.

15. The computer-readable medium of claim 14, wherein the method further comprising suppressing the at least one message based on a result of the evaluation of the optional marker.

16. The computer-readable medium of claim 14, wherein the optional marker comprising an annotation indicating whether an overflow condition is expected with respect to at least one of the first variable, the second variable, the at least one operation, the variable for storing the result of the at least one operation, or the portion of the code corresponding to the at least one block of the hardware module.

17. The computer-readable medium of claim 10, wherein the method further comprising automatically processing the code corresponding to the at least one block of the hardware module to generate a low-level representation of the code comprising at least one of timing information or routing information for the at least one block of the hardware module.

18. A system comprising:
at least one processor; and
at least one memory comprising instructions for:
receiving code corresponding to at least one block of the hardware module, wherein the code providing at least a first value for a first variable, a second value for a second variable, or an operation to be performed using the first variable or the second variable,
automatically generating an exception detector to determine whether an overflow condition is triggered by at least one of the operation, the first variable, or the second variable,
during processing of the code corresponding to the at least one block of the hardware module, despite the exception detector indicating that the overflow condition is triggered by the at least one of the operation, the first variable, based on a value of at least one marker embedded in the code ignoring the overflow condition.

19. The system of claim 18, wherein the at least one memory further comprising instructions for the exception detector determining a location in the code of a variable or an operation that triggered an overflow condition.

20. The system of claim 18, wherein the at least one memory further comprising instruction for, during processing of the code corresponding to the at least one block of the hardware module, based on the exception detector indicating that the overflow condition is triggered by the at least one of the operation, the first variable, or the second variable, automatically generating an exception wherein the at least one message further comprising (1) a first location in the code of the operation, to be performed using the first value for the first variable or the second value for the second variable, that triggered the overflow condition or (2) a second location in the code related to: (a) providing the first value for the first variable or (b) providing the second value for the second variable.
